(19) United States
(12) Patent Application Publication
(10) Pub. No.: US 2006/0206426 A1
(43) Pub. Date: Sep. 14, 2006

(54) Promise to purchase real estate system and method

(75) Inventor: Jonathan E. Powell, Anchorage, AK (US)

Correspondence Address: DAVIS WRIGHT TREMAINE, LLP, 2600 CENTURY SQUARE, 1501 FOURTH AVENUE, SEATTLE, WA, 98101-1688, US

(73) Assignee: Certified Services Exchange, Inc., Anchorage, AK (US)

(21) Appl. No.: 11/289,778

(22) Filed: Nov. 29, 2005

Related U.S. Application Data
(60) Provisional application No. 60/662,127, filed on Mar. 10, 2005.

(51) Int. Cl. G06Q 40/00

(52) U.S. Cl. 705/40

(57) ABSTRACT

The present system and method seeks to lessen impacts of market fluctuations, transaction costs, and other detrimental factors associated with conventional dwelling purchases while seeking also to provide more options in selection of dwellings to choose from by the household seeking such a dwelling. An exemplary implementation involves an initial purchaser and a subsequent purchaser who execute a promise to purchase agreement. The process further involves an initial seller, a bank, and an escrow agent. In some implementations, the subsequent purchaser is a real estate brokerage company with one or more brokers being licensed as real estate agents. The promise to purchase agreement between the initial purchaser and the subsequent purchaser governs certain actions by the initial purchaser and other actions by the subsequent purchaser regarding a particular real estate property.

### BACKGROUND OF THE INVENTION

Given the dynamic nature of many modern lifestyles, a household may occupy a particular dwelling for a period of time less than what may be needed to financially justify purchase of the dwelling. Alternatives to purchase include renting another dwelling over the period of time, but these alternatives may not be desirable. In some locations, dwellings available to rent may be limited to certain sizes, styles, or types. For instance, apartment dwellings are generally rented and may be readily available in many locations, but may not fulfill needs or desires of a household. It may be difficult to find an apartment setting that furnishes sufficient privacy, a quiet environment, or possibly enough space for a large household.

Rental houses may be available, but may generally fall in a certain range of sizes or otherwise may be limited so that certain needs or desires of a household go unfilled. On the other hand, houses or other types of dwellings that are available for purchase may offer a wider selection in a particular area than the other alternatives. So a sizeable number of households can face a quandary in satisfying both fiscal and other considerations.

### BRIEF DESCRIPTION OF THE SEVERAL VIEWS OF THE DRAWING(S)

FIG. 1A is a first portion of a flowchart of an exemplary implementation of an implementation of the promise to purchase real estate system and method.

FIG. 1B is a second portion of a flowchart of an exemplary implementation of the implementation of the promise to purchase real estate system and method shown in FIG. 1A.

### DETAILED DESCRIPTION OF THE INVENTION

A promise to pay real estate system and method, discussed herein, addresses situations, for instance, when a household may plan to be located in an area for a limited time period that is insufficient to justify purchase of a dwelling that they would otherwise inhabit. Generally when habitation of a dwelling is for a relatively short period of time, potential market fluctuations and transaction costs associated with a potential purchase of a dwelling tend to be more of a factor in the decision process whether to purchase a dwelling or inhabit an alternative rental.

Furthermore, when a household has fairly definite plans to only inhabit a dwelling for a relatively fixed period of time, more pressure is brought to bear on selling a dwelling at the end of such time period regardless of possible poor market conditions, lack of success of a particular sales campaign, or other factors that may encourage a household to consider waiting for a more opportune time to sell the dwelling. This future pressure to sell a dwelling before a household has even bought the dwelling can tend to dissuade potential purchases presently considered and motivate households to accept less than what they may really need or desire.

The present system and method provide an alternative approach to conventional dwelling purchases and conventional rental arrangements. The present system and method seeks to lessen impacts of market fluctuations, transaction costs, and other detrimental factors associated with conventional dwelling purchases while seeking also to provide more options in selection of dwellings to choose from by the household seeking such a dwelling.

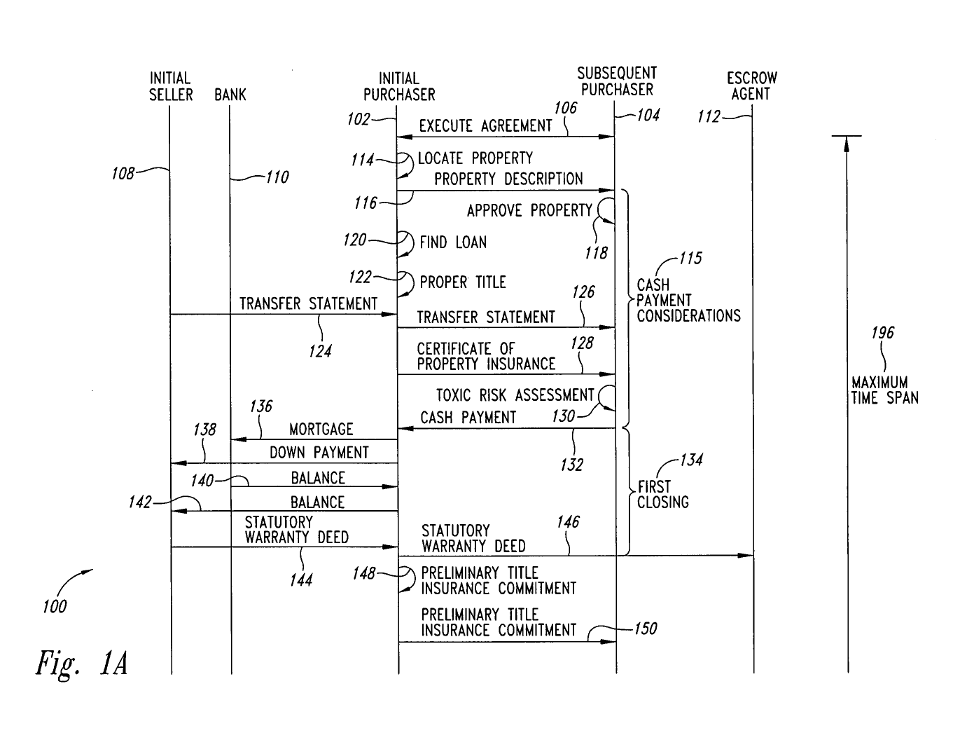

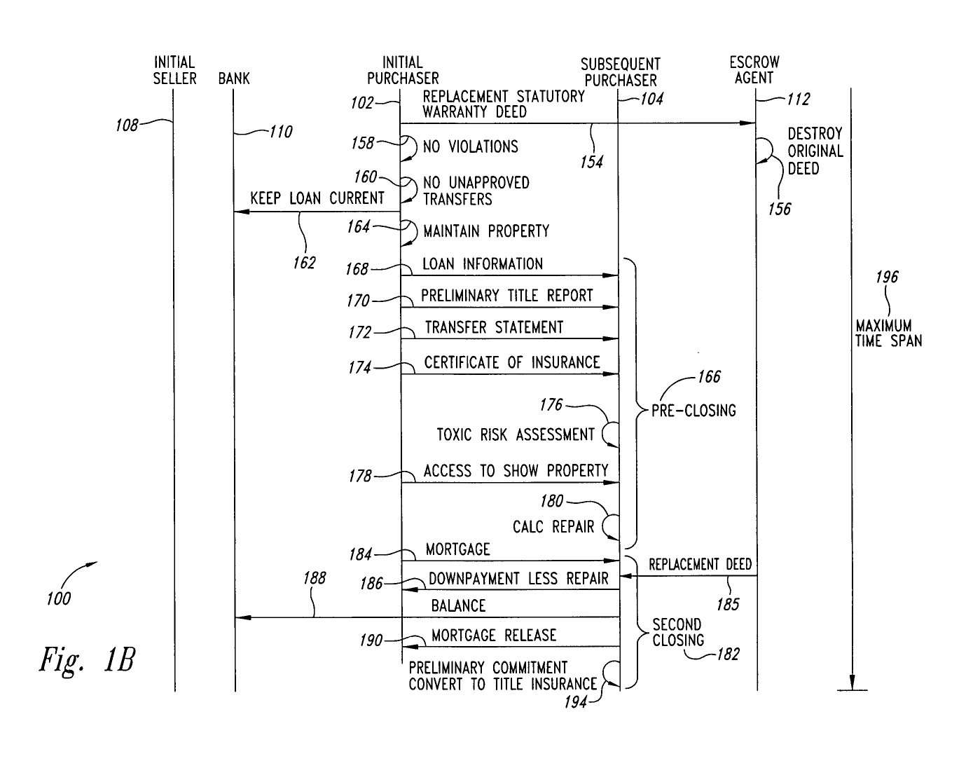

An exemplary implementation of the present system and method is depicted by a process 100 shown in FIGS. 1A and 1B and involves an initial purchaser 102 and a subsequent purchaser 104 who execute a promise to purchase agreement (step 106) between each other. The process 100 further involves an initial seller 108, a bank 110 or other lending source, and an escrow agent 112, which will be further discussed below. In some implementations, the subsequent purchaser 104 can be a real estate brokerage company with one or more brokers being licensed as real estate agents.

The promise to purchase agreement between the initial purchaser 102 and the subsequent purchaser 104 governs certain actions by the initial purchaser and other actions by the subsequent purchaser regarding a particular real estate property (“the property”). According to the promise to purchase agreement, the initial purchaser 102 agrees to diligently locate and purchase the property shortly after the promise to purchase agreement has been executed. In the depicted implementation, the initial purchaser 102 locates the property with the intent to use the property as the initial purchaser's residence. Also, according to the promise to purchase agreement, the intial purchaser 102 agrees to sell and the subsequent purchaser 104 agrees to buy the property at a certain point in the future, under and subject to the terms of the promise to purchase agreement.

The initial purchaser 102 could be an exemplary household that anticipates requiring a dwelling for an intermediate span of time such as approximately three or so years. This intermediate time typically would tend to be more than what one would consider a short term such as a few weeks or a few months, but typically would be shorter than what may be customarily considered a usual occupancy period to purchase a dwelling in which to live. The example of three or so years is a representative span of time for the homebuyer to plan to occupy the dwelling, but could be other spans of time given other implementations or examples.

After the promise to purchase agreement is executed (step 106), the initial purchaser 102 diligently locates a property to potentially be considered as the property to be purchased by the initial purchaser and to be associated with the promise to purchase agreement (step 114). Under the promise to purchase agreement and with the subsequent purchaser 104 being a real estate broker, the initial purchaser 102 may use, but is not obligated to use the subsequent purchaser in connection with the locating and purchasing of the property by the initial purchaser. In a case in which the initial purchaser 102 so chooses to use the subsequent purchaser 104, the subsequent purchaser is typically entitled to a commission in connection with the purchase of the property by the initial purchaser in accordance with a commission agreement separate from the promise to purchase agreement. Regardless of these arrangements in assisting the initial purchaser 102 with the locating and/or purchase of the property, the subsequent purchaser 104 is still bound by the promise to purchase agreement.

After the initial purchaser 102 locates a candidate property to be potentially purchased by the initial purchaser, various activities are performed by the initial purchaser 102 and the subsequent purchaser 104 as part of cash payment considerations 115.

Included with the cash payment considerations 115, the initial purchaser 102 gives to the subsequent purchaser 104 a legal description of the candidate property conforming to requirements of the promise to pay agreement (step 116), which includes in the depicted implementation, the house and all improvements located on the candidate property. The subsequent purchaser 104 reviews the property description of the candidate property and performs possibly other review activities associated with the promise to purchase agreement of the candidate property. Based on the sole discretion of the subsequent purchaser 104, if the one or more reviews are satisfactory to the subsequent purchaser, the candidate property is approved as the property to be purchased by the initial purchaser 102 (step 118). Otherwise, the initial purchaser 102 addresses deficiencies of the candidate property raised by the subsequent purchaser 104 if possible to secure approval of the candidate property by the subsequent purchaser. If deficiencies are not satisfactorily addressed, under the presently depicted implementation, the initial purchaser 102 will return to diligently locate another candidate property (step 114).

Upon approval of the candidate property by the subsequent purchaser 104 (step 118), if the initial purchaser 102 does not have personal funds sufficient to purchase the property outright, the initial purchaser finds a loan for the property (step 120) acceptable to the subsequent purchaser. In some implementations the subsequent purchaser 104 may formally review and approve the loan. As will be further discussed, in many situations under the promise to purchase agreement, the loan will be assumed by the subsequent purchaser 104. In other implementations of the promise to purchase agreement, the loan could be assumed at a later future time by a third party that possibly will purchase the property from the initial purchaser 102 through coordination and cooperation with the subsequent purchaser 104. In order for the loan to be consider assumable, the subsequent purchaser 104 will verify whether the loan is assumable at least by the subsequent purchaser based on the sole discretion of the subsequent purchaser. The subsequent purchaser 104 will also review for approval by the subsequent purchaser, terms of the loan documents including the terms of any deed of trust planned to secure the loan.

In some implementations, the initial purchaser 102 warrants that the execution, recordation, and performance of the promise to purchase agreement are not a breach of, and are not prohibited by, any term of the initial purchaser's loan, including without limitation any deed of trust securing the initial purchaser's loan. The initial purchaser 102 shall be solely responsible for, and waives and releases the subsequent purchaser 104 from any claim arising out of or relating to, any action by any lender, beneficiary, holder or other third party in response to the execution, recordation, or performance of the promise to purchase agreement.

The initial purchaser 102 acknowledges that unless the initial purchaser is released by the lender on the initial purchaser's loan, the initial purchaser will remain liable on the loan even if it is assumed by the subsequent purchaser 104 in accordance with the promise to purchase agreement, and such continuing liability may affect the initial purchaser's ability to obtain other loans or credit. In some implementations, without limiting the foregoing, the initial purchaser 102 acknowledges that if the loan is a Veteran's Administration (“VA”) loan, the initial purchaser will be ineligible for a further VA loan until the loan is paid in full by the subsequent purchaser 104. Regarding the subsequent assumption by the subsequent purchaser 104 of the initial purchaser's loan under the promise to purchase agreement, the subsequent purchaser is not required to obtain release by the initial purchaser regarding liability on the loan of the initial purchaser. In some implementations, under no circumstances will the subsequent purchaser 104 be liable for any indirect, incidental, special or consequential damages in connection with any claim arising out of or relating to this contract, even if the subsequent purchaser 104 has been advised of the possibility of such.

Also included with the cash payment considerations 115, the initial purchaser 102 has a title check performed on the property to insure that title to the property is proper (step 122). For instance, except a deed of trust securing the loan, the title shall be clear of encumbrances, unless the subsequent purchaser 104 will pay off the loan. Other possibly allowable encumbrances could include conditions, restrictions, reservations, rights-of-way, easements, and covenants of record which do not affect marketability of title as approved by the subsequent purchaser 104.

The initial purchaser 102 obtains a transfer statement from the initial seller 108 (step 124). The initial purchaser 102 then forwards a copy of the transfer statement to the subsequent purchaser 104 (step 126). The initial purchaser 102 forwards a copy of a certificate of property insurance to the subsequent purchaser 104 (step 128).

Under the promise to purchase agreement, the subsequent purchaser 104 has the prerogative to have a toxic risk assessment performed regarding the property (step 130). This toxic risk assessment typically could involve issues regarding lead paint used in a dwelling associated with the property and/or regarding presence of radon on the property. The subsequent purchaser 104 is typically required to pay for such reviews since their initiation is based upon the discretion of the subsequent purchaser. The results of the reviews are accepted or rejected can be based upon the sole discretion of the subsequent purchaser 104.

Provided that all the activities identified as part of the cash payment considerations 115 have been carried out, the subsequent purchaser 104 will then transfer a cash payment to the initial purchaser 102 (step 132) in a certain amount of cash or cash equivalent as stipulated in the promise to purchase agreement. For instance, in some implementations the subsequent purchaser 104 will transfer a cash amount of approximately $7000 to the initial purchaser 102. If any of the cash payment considerations 115 are not resolved or otherwise corrected within a particular time period as specified in the promise to purchase agreement, the subsequent purchaser 104 may at the sole option of the subsequent purchaser either waive any unmet conditions of the cash payment considerations and proceed to pay the cash amount to the initial purchaser 102, or terminate the promise to purchase agreement. If the subsequent purchaser 104 wishes to terminate based on unmet conditions, both the initial purchaser 102 and the subsequent purchaser are release from any further obligation under the promise to purchase agreement. Furthermore, the cash payment is non-refundable once it is paid by the subsequent purchaser 104 to the initial purchaser 102 except for certain exceptions discussed below.

The initial purchaser 102 then goes through a first closing (step 134) with the initial seller 108 to transfer ownership of the property from the initial seller to the initial purchaser. The transfer of the cash payment to the initial purchaser 102 from the subsequent purchaser 104 can occur either before or during the first closing 134. In some implementations, the subsequent purchaser 104 is not responsible for any aspect of the purchase of the property by the initial purchaser. Without limiting the foregoing, the subsequent purchaser 104 cannot typically be responsible for any closing costs associated with the first closing (step 134).

The first closing 134 includes the initial purchaser 102 giving a mortgage to the bank 110 (step 136) and a down payment to the initial seller 108 (step 138). It is understood that modern conventional banking involves complexities in organization and procedures that are known in the art so that although the bank 110 is treated herein as a single entity, it could also be a number of different entities due to processes that occur before, during, or after various closings discussed or at other times. In exchange for the mortgage, the bank 108 transfers balance funds to the initial purchaser 102 to cover the remaining balance for purchase of the property (step 140). The initial purchaser then passes the balance funds to the initial seller (step 142). This exemplary depiction is not intended as a full course in conventional real estate practice. Rather the depicted implementations are intended to provide sufficient detail to teach how the system would be integrated into a conventional real estate practice by non-limiting examples. In exchange for the down payment and the balance funds received from the initial purchaser 102, the initial seller 108 transfers title to the initial purchaser 102 such as by transferring a first statutory warranty deed (step 144).

In accordance with the promise to purchase agreement, after receiving the cash payment (step 132), the initial purchaser 102 then forwards to the escrow agent 112 a second statutory warranty deed written to convey title to the subsequent purchaser 104 (step 146). In some implementations, the initial purchaser 102 may alternatively forward the second statutory warranty deed to the subsequent purchaser 104 to hold. The initial purchaser 102 authorizes and directs the escrow agent 112 to hold the second statutory warranty deed until a second closing (step 182) described below. The initial purchaser 102 also authorizes and directs the escrow agent 112 to deliver the second statutory warranty deed or subsequent replacement statutory warranty deed to the subsequent purchaser 104 upon certain transfers by the subsequent purchaser or by a third party. The transfers include one or more funds transfers and possibly an assumption of the initial purchaser's loan with the second closing (step 182) described below. The initial purchaser 102 obtains a preliminary title insurance commitment (step 148) and then gives a copy of the preliminary title insurance commitment to the subsequent purchaser 104 (step 150).

According to the promise to payment agreement, at some point during ownership of the property by the initial purchaser 102, the subsequent purchaser 104 may require the initial purchaser to execute and deliver into escrow with the escrow agent 112 a replacement statutory warranty deed conveying title to a third party grantee as the subsequent purchaser may designate (step 154). Further regarding the replacement statutory warranty deed, the initial purchaser will direct the escrow agent 112 to destroy the statutory warranty deed (step 156) previously deposited in step 146 and to hold the replacement statutory warranty deed until the initial purchaser transfers ownership at the second closing (step 182) described below. The initial purchaser 102 will also direct the escrow agent 112 to deliver the replacement statutory warranty deed to the third party grantee designated therein upon fulfillment of transfers by the subsequent purchaser 104 associated with the second closing (step 182) described below. Upon receipt of the replacement statutory warranty deed, the escrow agent 112 destroys the original statutory warranty deed (step 156).

In accordance with the promise to purchase agreement, during ownership of the property by the initial purchaser 102, the initial purchaser has certain duties. For instance, the initial purchaser is to refrain from violations (step 158). The initial purchaser 102 is not to undergo any transfer of title or other transfers related to the property without approval by the subsequent purchaser 104 (step 160). Furthermore, the initial purchaser 102 will not create or place or permit to be created or placed, or through any act or failure to act, acquiesce in the creation or placing of, or allow to remain, any voluntary or involuntary lien, encumbrance, charge, or interest of any kind whatsoever against the property, regardless of whether the same are expressly or otherwise subordinate to the rights of the subsequent purchaser 104 under the promise to purchase agreement.

The initial purchaser 102 is to keep the loan with the bank 110 current by making timely payments to the bank (step 162). The initial purchaser 102 must keep the property in a proper state of maintenance (step 164). According to the promise to purchase agreement, pending closing by the subsequent purchaser 104 further discussed below, the initial purchaser 102 maintains the property in the same condition as existed at the date of execution of the promise to purchase agreement (step 106). Normal wear and tear are, however, allowable. In this exemplary implementation, the initial purchaser 102 shall not make any modifications, additions or construction to the property without first obtaining the written approval of the subsequent purchaser 104, which approval shall not be unreasonably withheld. In some implementations, notwithstanding the exception for normal wear and tear, the initial purchaser 102 shall have responsibilities such as being responsible for cleaning or repainting the walls to their original condition, for having the carpets professionally cleaned, and for repairing or replacing any defective or malfunctioning electrical, mechanical, or plumbing systems or fixtures.

The initial purchaser 102 can be required to make repairs under insurance related maintenance provisions of the promise to purchase agreement, regardless of whether such insurance is actually in force. If the initial purchaser 102 fails to maintain the property as required by the promise to purchase agreement or if the initial purchaser 102 makes modifications, additions, or construction without the written approval of the subsequent purchaser 104, then in some implementations, the amount of funds or the amount of other transfers, such as involving assuming the initial purchaser's loan, required for the subsequent purchaser 104 to obtain ownership of the property can be reduced by an amount which the subsequent purchaser reasonably estimates as associated repair costs necessary to repair or restore the property. If the amount of these estimated repair costs is greater than the down payment paid by initial purchaser 102 at the time of the first closing 134, then the initial purchaser 102 shall pay the difference to the subsequent purchaser 104 at the second closing 182 discussed further below.

The system 100 will typically have provisions in the promise to purchase agreement indicating a period of time that the initial purchaser 102 will own the house based on a starting date typically being the execution date of the promise to purchase agreement. The provisions could require a particular duration for the period of time, such as a mutually agreed upon duration lasting no more than three years, but also could have some flexibility to adjust the length of the period of time to correspond with particular employment obligations or other obligations of the initial purchaser 102. For instance, the provisions could be tied in with a particular military status of the initial purchaser 102 such as whether the initial purchaser continues to be on a tour of duty at a particular military installation, in a particular geographical region, such as a state of the United States, or in some military or other status. If so linked to a military status, the provisions may give to the initial purchaser 102 a right to extend the duration of residence in the property to a fixed period of years, such as four years, or to extend as long as the particular tour of duty or military status continues.

Prior to transfer of the property from the initial purchaser 102 to the subsequent purchaser 104, a pre-closing period 166 occurs involving a number of conditions and activities by the initial purchaser and the subsequent purchaser. Regarding some conditions, during the pre-closing period 166, pending the second closing 182, the initial purchaser 102 will not use the property in violation of any law, any terms of any insurance required under the promise to pay agreement, or any terms of any of associated loan documents, including without limitation the terms of any deed of trust securing the associated loan. The initial purchaser 102 will not rent or sublease or assign any interest in the property to any other entity without the advance written permission of subsequent purchaser 104. Furthermore, the initial purchaser 102 will make all payments required by, and will otherwise comply with, the terms of the associated loan documents, including without limitation, the terms of any deed of trust securing the loan.

Other steps of the pre-closing 166 are followed. The initial purchaser 102 sends loan information to the subsequent purchaser 104 so that the subsequent purchaser can review and approve the loan (step 168). The initial purchaser 102 sends a preliminary title report to the subsequent purchaser 104 (step 170). The initial purchaser 102 sends a transfer statement to the subsequent purchaser 104 (step 172).

The initial purchaser 102 sends a certificate of insurance to the subsequent purchaser 104 (step 174). The certificate of insurance shows the initial purchaser's compliance with insurance requirements as described in the promise to purchase agreement since the initial purchaser 102 is required by the promise to purchase agreement to insure during the time of ownership of the property by the initial purchaser the property such as the house and any improvements located on the property against loss or damage on an all risk basis in an amount equal to the full replacement cost of the house.

This insurance typically names the subsequent purchaser 104 as an additional insured as interest of the subsequent purchaser may appear. The insurance also typically requires notification of the subsequent purchaser 104 at least a certain period time, such as 30 days, before any expiration of the insurance can occur. The insurance typically cannot be canceled either by the initial purchaser 102 or elsewise unless the insurer of the insurance first gives at least a certain period time, such as 30 days, for prior written notice to the subsequent purchaser 104 that the insurance is to be canceled.

Under the promise to pay agreement, the initial purchaser 102 may also be required to cause to be delivered to the subsequent purchaser 104 from time to time photocopies of the policy of insurance, certificates of insurance, and copies of endorsements as requested by the subsequent purchaser. Typically, the promise to purchase agreement stipulates that in the event of any damage or destruction of the house on the property, all proceeds of insurance shall be used to promptly repair or rebuild the house. The subsequent purchaser 104 can have reviews performed regarding possible toxic conditions such as involving lead based paint or radon existing on the property (step 176).

The initial purchaser 102 allows access to the subsequent purchaser 104 to show the property to third parties that may be interested in purchasing the property (step 178). In some implementations, the promise to purchase agreement will stipulate conditions such as the access to the property by the subsequent purchaser does not start until a certain point in time, such as 60 days before the closing on the property by the subsequent purchaser 104. Other stipulations can include requiring the subsequent purchaser 104 to give at least 24 hour notification to the initial purchaser 102 before the subsequent purchaser can have access to the property for showing to a potential third party purchaser.

The subsequent purchaser 104 calculates an estimate as to any costs involved to repair the property to bring the property back to an acceptable state relative to its state when the initial purchaser purchased the property (step 180). After the obligations of the initial purchaser 102 and the subsequent purchaser 104 have been accomplished regarding the pre-closing 166 and any additional obligations such as maintenance of the property by the initial purchaser 102 (step 154), the second closing 182 occurs. If any obligations are not accomplished before the second closing 182 has been scheduled to occur, the subsequent purchaser 104 has the option of either waiving any unmet obligations or terminating the promise to purchase agreement at which point the subsequent purchaser has no further obligations thereto. If the subsequent purchaser 104 terminates the promise to purchase agreement for an unmet obligation of the initial purchaser 102, then the initial purchaser is required to refund to the subsequent purchaser 104 the cash payment received in step 132 by the initial purchaser from the subsequent purchaser.

Before the second closing 182, the initial purchaser 102 may be in default under the promise to pay agreement under certain conditions. For instance, in some implementations, a condition could be that the initial purchaser 102 breaches any provision of the promise to purchase agreement and such breach goes uncured after ten days' notice of such default. Another condition could be that the property or any part thereof is seized by any governmental authority or creditor and the initial purchaser 102 does not obtain the prompt and unconditional release of what was seized. An example of this later condition could be when a bankruptcy petition is filed, or other federal or state insolvency proceeding is commenced, by or against the initial purchaser 102. Another condition could be when the property 102 or other property of the initial purchaser 102 is made the subject of a receivership. Another could be when the initial purchaser 102 makes a general assignment for the benefit of creditors. In the event of default, then in addition to any other rights and remedies available to the subsequent purchaser 104 at law or in equity, the subsequent purchaser has an optional right, (a) to immediately terminate the promise to purchase agreement and recover damages; or (b) to require that the initial purchaser 102 immediately close and convey title under the promise to purchase agreement while otherwise continuing the promise to purchase agreement in force, and recover damages.

The second closing 182 may include assumption of the mortgage 184 by the subsequent purchaser 104 from the initial purchaser 102 (step 184). The escrow agent 112 either transfers the original statutory warranty deed to the subsequent purchaser 104 conveying title thereto or alternatively transfers the replacement statutory warranty deed (if step 154 and step 156 occur) to the third party designated therein conveying title thereto. The statutory warranty deed or the replacement statutory warranty deed must be in a form acceptable to the subsequent purchaser 104.

The subsequent purchaser 104 must transfer funds to the initial purchaser 102 in an amount at least approximating the down payment paid by the initial purchaser 102 to the initial seller 108 in step 138 less the estimation of costs for repairs determined in step 180 by the subsequent seller (step 186). If the subsequent purchaser 104 does not assumed the loan of the initial purchaser 102, then the subsequent purchaser 104 has an option of transferring funds to the bank 110 at least approximating the outstanding balance of the loan that the initial purchaser 102 had with the bank (step 188). Under the promise to purchase agreement, typically the subsequent purchaser 104 pays off the initial purchaser's remaining balance of the loan either by assuming the loan (see step 184), by paying off the loan (see step 188), or by having a third party pay off or assume the loan (not shown).

The subsequent purchaser 104 is also obligated under the promise to purchase agreement for the initial purchaser's down payment less repair costs (see step 186). The subsequent purchaser 104, however, is not under obligation to adjust the amount of the funds transferred that are associated with the payments based on an increased fair market value of the property from the period of the first closing 134 to the period of the second closing 182. On the other hand, the subsequent purchaser 104 also cannot adjust the amount of funds transferred based on a decreased fair market value of the property. Other funds transfers can occur such as for paying taxes on the property. Typically, taxes on the property will be prorated as to the date of the second closing 182.

If the subsequent purchaser 104 chooses to pay off the loan to the bank 110, at this point, the mortgage that was transferred to the subsequent purchaser 104 is no longer in effect. The subsequent purchaser 104 may also release the initial purchaser 102 from any outstanding obligations under the loan with the bank 110 (step 190). Also, even though the subsequent purchaser 104 may be a realty company or agent, the subsequent purchaser shall not be entitled to a commission in connection with the subsequent purchaser's purchase of the property through the transfers to the subsequent purchaser described above.

During the second closing 182, the preliminary title insurance commitment received by the subsequent purchaser 104 in step 150 is converted into an owner's title policy for the subsequent purchaser (step 194). As shown, all activities ending with the second closing 182 are completed within a maximum time span 196 according to the promise to pay agreement starting with execution of the agreement in step 106.

From the foregoing it will be appreciated that, although specific embodiments of the invention have been described herein for purposes of illustration, various modifications may be made without deviating from the spirit and scope of the invention. Accordingly, the invention is not limited except as by the appended claims.

The invention claimed is

1. A method comprising:
executing an agreement between a first party and a second party;
after executing the agreement, the first party identifying a real property to the second party as according to the agreement;
after identifying the real property, the second party approving the real property and giving authorization to the first party to receive at least one cash payment consideration as according to the agreement based upon the approval of the real property by the second party;
after approval of the real property by the second party, the second party transferring funds to the first party based upon satisfaction of the at least one cash payment consideration as according to the agreement; and
after the second party transferring funds to the first party, a party other than the second party providing the first party with title to the real property.

2. The method of claim 1, further comprising the first party providing funds as a down payment for the real property.

3. The method of claim 2, further comprising after a time period according to the agreement the second party providing to the first party second funds in an amount based upon the down payment provided by the first party for the real property; and providing to the second party a document conveying title to the second party.

4. The method of claim 3 wherein the document is provided to the second party contingent at least in part upon the first party receiving the second funds from the second party.

5. The method of claim 4, further comprising providing the first party with the title to the real property contingent at least in part upon obtaining a loan for funds to purchase at least a portion of the real property.

6. The method of claim 4, further comprising after a time period according to the agreement, the first party owing a balance on the real property to another party, and the second party paying funds to the another party according to the balance and the document being released to the second party contingent further at least in part upon the balance being paid to the another party by the second party.

7. The method of claim 3 wherein the amount of second funds provided by the second party to the first party is the amount of the down payment less an amount of funds determined by the second party to return the real property to a prior state before experiencing indefinite change specified in the agreement due to actions by the first party.

8. The method of claim 1 wherein the title to the real property provided to the first party is a statutory warranty deed.

9. The method of claim 1, further comprising after providing the first party with title to the real property, the first party providing a copy of a preliminary title insurance commitment for the real property to the second party.

10. The method of claim 1, further comprising after providing the title to the real property, the first party providing a document, the document written to convey title on the real property to the second party.

11. The method of claim 10, further comprising, after the first party providing the document, the document being destroyed and the first party providing a second document written to convey title to the real property to a party other than the first party and other than the second party, as designated to the first party by the second party.

12. The method of claim 10 wherein the document is an statutory warrant deed.

13. The method of claim 1, further comprising after a time period as according to the agreement, the second party being provided a document written to convey title to the second party.

14. The method of claim 13 wherein the document is a deed.

15. The method of claim 1, further comprising after a time period as according to the agreement, the first party granting access to the second party to show the real property to at least one other party.

16. The system of claim 1 wherein the at least one cash payment considerations to be satisfied by the first party includes at least one of providing a property description of the real property to the second party, finding a loan for funds for the first party to use in part to acquire title to the real property and that are assumable by the second party, providing the first party with a transfer statement regarding the real property and providing a copy of the transfer statement to the second party, providing a certificate of property insurance on the real property to the second party, and the second party initiating a toxic risk assessment of the real property.

17. The system of claim 1 further comprising the first party transferring additional funds to a third party having control of title to the real property, the third party providing title to the first party upon receipt of the additional funds.
